(19) United States
(12) Patent Application Publication
(10) Pub. No.: US 2016/0256984 A1
(43) Pub. Date: Sep. 8, 2016

(54) PLIER STRUCTURE

(71) Applicant: Feng-Chung Liu, Taichung City (TW)

(72) Inventor: Feng-Chung Liu, Taichung City (TW)

(21) Appl. No.: 14/636,129

(22) Filed: Mar. 2, 2015

(51) Int. Cl. B25B 7/14

(52) U.S. Cl. CPC B25B 7/14

(57) ABSTRACT

A spring clamp comprises a spring clamp, a pull bar and a pressing handle. The spring clamp utilizes the shaft rod to be pivoted with the first arm and the second arm. The first arm is connected to a connecting bar, and the second arm is provided with a slot facing the first grip and a linkage rod across the slot the pull bar. An end of the pull bar is connected to the connecting bar of the first arm, and another end of the pull bar is disposed in the slot. The pressing handle is provided with a pivoting portion accepting the linkage rod, and the pressing handle is further provided with a divider close to the pivoting portion, and the divider is jacketed onto the pull bar. The pressing handle further is provided with a pressing portion opposite from an end of the pull bar and a second spring between the pressing portion and the second grip. The distance between the second spring and the pivoting portion longer than a distance between the divider and the pivoting portion to increase the force provided by the second spring.

### BACKGROUND OF THE INVENTION

1. Field of the Invention

The present invention relates to a spring clamp structure, and more particularly to an improved spring clamp.

2. Description of the Related Art

Currently, a typical spring clamp generates pushing forces at two opposite directions which can cancel each other and cause poor stability. Also, the spring utilized on the typical spring clamp cannot be replaced or exchanged for different purposes easily. Furthermore, the typical spring clamp have a limited opening which causes lower accuracy.

Therefore, it is desirable to provide an improved spring clamp to mitigate and/or obviate the aforementioned problems.

### SUMMARY OF THE INVENTION

An objective of the present invention is to provide an improved spring clamp.

In order to achieve the above mentioned objective, a spring clamp comprises a spring clamp, a pull bar and a pressing handle. The spring clamp further comprises a first arm, a second arm, a shaft rod and a first spring. The first spring is jacketed onto the shaft rod, and the shaft rod is pivoted between the first arm and the second arm. The first spring further comprises a front end portion and a rear end portion, and the front end portion of the first spring is engaged with the second arm and the rear end portion is engaged with the first arm. The first arm is provided with a first grip and connected to a connecting bar. The second arm is provided with a second grip, and the second grip is provided with a slot facing the first grip and a linkage rod across the slot. The second grip is further provided with a metal member, a through aperture is disposed in the metal member, and the through aperture is configured for accepting the linkage rod. An end of the pull bar is connected to the connecting bar of the first arm, and another end of the pull bar is disposed in the slot of the second grip. The pull bar further comprises a curved section corresponding to a relative angle between the first arm and the second grip to increase a distance between the connecting bar and the shaft rod. A pressing handle is disposed in the slot of the second grip and covers the pull bar, and the pressing handle is provided with a pivoting portion accepting the linkage rod. The pressing handle is further provided with a divider close to the pivoting portion and a positioning aperture disposed on the divider, and the positioning aperture is jacketed onto the pull bar. The pressing handle is made of plastic and two sides of the pressing handle respectively extend as a sidewall with an engaging groove corresponding to each other. The divider is made of metal and the divider is inserted into the engaging groove of the sidewall. The pressing handle is further provided with a pressing portion opposite from an end of the pull bar and a second spring between the pressing portion and the second grip. The second grip further comprises a protrusion in the slot, and the protrusion is inserted into the second spring for positioning

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of a preferred embodiment of the present invention.

FIG. 2 is an exploded view of the embodiment of the present invention.

FIG. 3 is a cross-sectional view of the embodiment of the present invention.

FIG. 4 shows a schematic drawing of the embodiment of the present invention.

FIG. 5 shows another schematic drawing of the embodiment of the present invention.

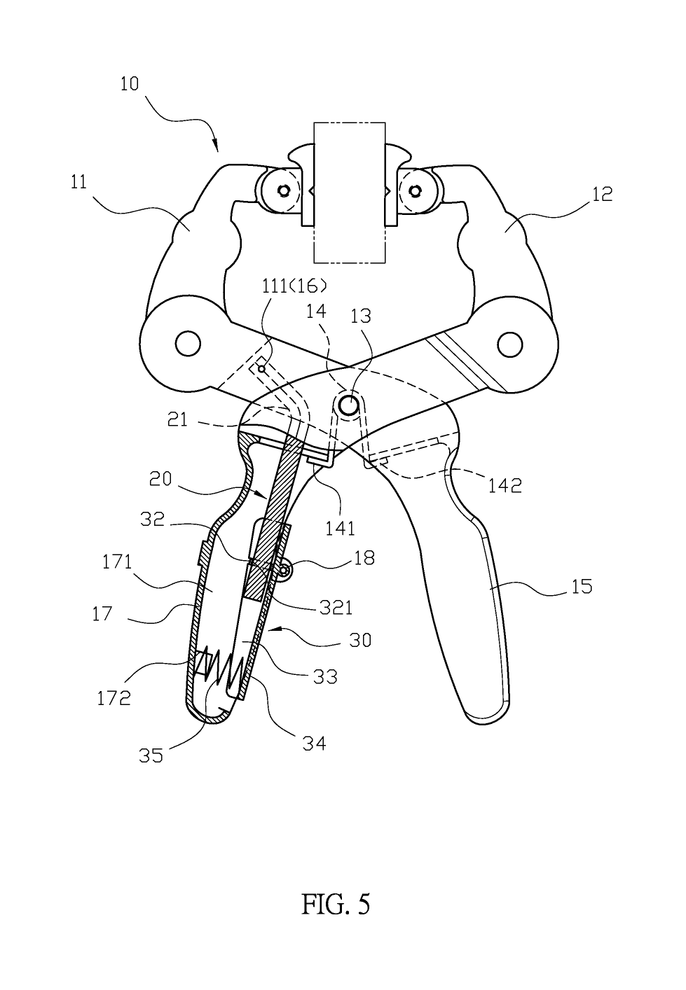

FIG. 6 is a cross-sectional view of another embodiment of the present invention.

FIG. 7 is a cross-sectional view of another embodiment of the present invention.

### DETAILED DESCRIPTION OF THE PREFERRED EMBODIMENT

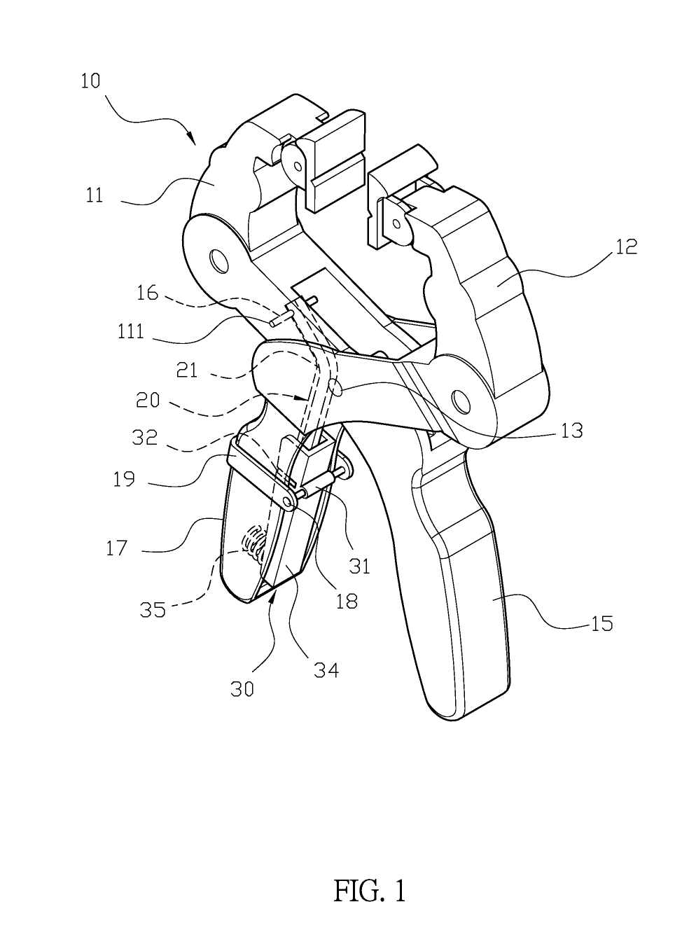

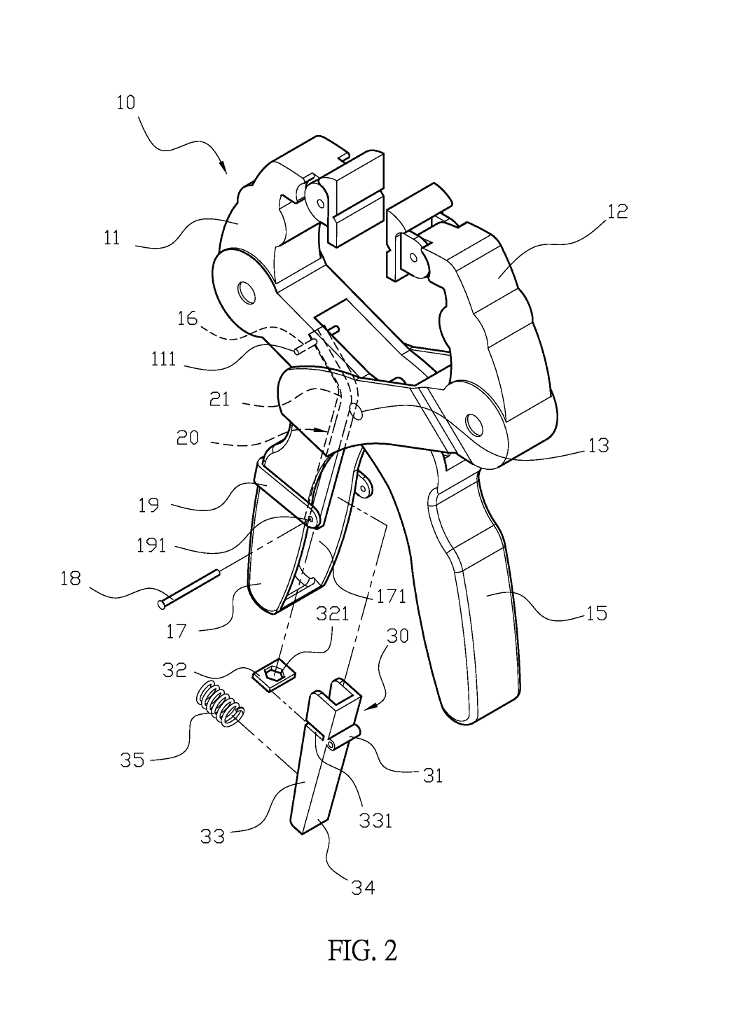

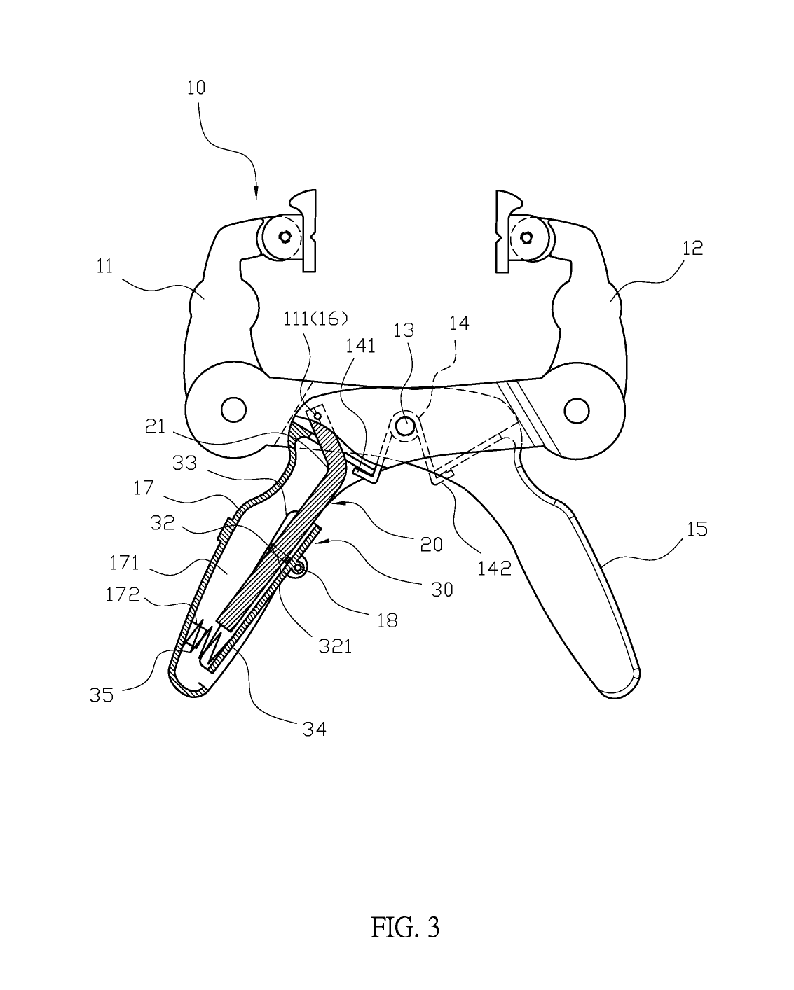

Please refer to FIG. 1, FIG. 2 and FIG. 3. A spring clamp comprises a spring clamp 10, a pull bar 20 and a pressing handle 30. The spring clamp 10 further comprises a first arm 11, a second arm 12, a shaft rod 13 and a first spring 14. The first spring 14 is jacketed onto the shaft rod 13, and the shaft rod 13 is pivoted between the first arm 11 and the second arm 12. The first spring 14 further comprises a front end portion 141 and a rear end portion 142, and the front end portion 141 of the first spring 14 is engaged with the second arm 12 and the rear end portion 142 is engaged with the first arm 11. The first arm 11 is provided with a first grip 15 and connected to a connecting bar 16. The second arm 12 is provided with a second grip 17, and the second grip 17 is provided with a slot 171 facing the first grip 15 and a linkage rod 18 across the slot 171. The second grip 17 is further provided with a metal member 19, a through aperture 191 is disposed in the metal member 19, and the through aperture 191 is configured for accepting the linkage rod 18. An end of the pull bar 20 is connected to the connecting bar 16 of the first arm 11, and another end of the pull bar 20 is disposed in the slot 171 of the second grip 17. The pull bar 20 further comprises a curved section 21 corresponding to a relative angle between the first arm 11 and the second grip 17 to increase a distance between the connecting bar 16 and the shaft rod 13. A pressing handle 30 is disposed in the slot 171 of the second grip 17 and covers the pull bar 20, and the pressing handle 30 is provided with a pivoting portion 31 accepting the linkage rod 18. The pressing handle 30 is further provided with a divider 32 close to the pivoting portion 31 and a positioning aperture 321 disposed on the divider 32, and the positioning aperture 321 is jacketed onto the pull bar 20. The pressing handle 30 is made of plastic and two sides of the pressing handle 30 respectively extend as a sidewall 33 with an engaging groove 331 corresponding to each other. The divider 32 is made of metal and the divider 32 is inserted into the engaging groove 331 of the sidewall 33. The pressing handle 30 is further provided with a pressing portion 34 opposite from an end of the pull bar 20 and a second spring 35 between the pressing portion 34 and the second grip 17. The second grip 17 further comprises a protrusion 172 in the slot 171, and the protrusion 172 is inserted into the second spring 35 for positioning

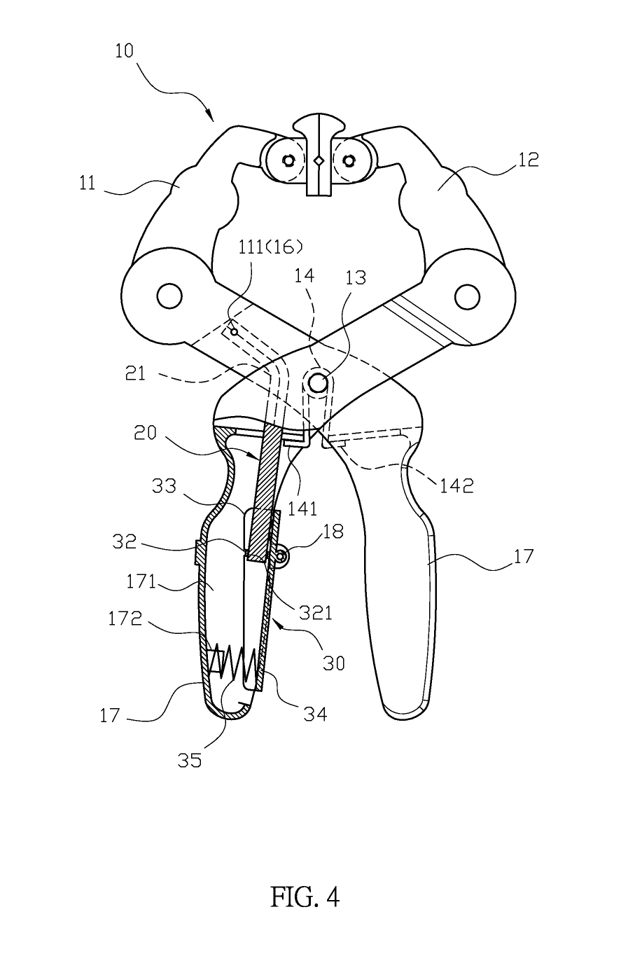

For actual usage, please refer to FIG. 1 to FIG. 4. The shaft rod 13 of the spring clamp 10 is inserted through the first arm 11, the second arm 12 and the first spring 14 to pivot the first arm 11 and the second arm 12 together. The front end portion 141 of the first spring 14 engages with the second arm 12, the rear end portion 142 of the first spring 14 engages with the first arm 11, such that the first spring 14 force the first and second arms 11, 12 to be apart. One end of the pull bar 20 is disposed in the slot 171 of the second grip 17, another end of the pull bar 20 is placed into the first arm 11 and pivoted with the connecting bar 16 onto the first arm 11. The positioning aperture 321 of the divider 32 is jacketed onto the pull bar 20, the second spring 35 is jacketed onto the protrusion 172 of the second grip 17, and the pressing handle 30 is accepted in the slot 171 such that the two sidewalls 33 of the pressing handle 30 cover the pull bar 20. Furthermore, the engaging groove 331 of the pressing handle 30 engages with the divider 32, the pressing portion 34 presses onto the second spring 35, the linkage rod 18 is placed through the through aperture 191 of the metal member 19 and the pivoting portion 31 of the pressing handle 30, therefore, the pressing handle 30 is pivoted onto the second grip 17. While using the spring clamp 10, the first grip 15 and the second grip 17 are pressed close toward to each other to bring the first arm 11 and the second arm 12 together. Meanwhile, the pull bar 20 is pulled by the connecting bar 16 and moves out of the positioning aperture 321 such that the positioning aperture 321 of the divider 32 is not holding the pull bar 20 anymore. Moreover, when the first and second grips 15, 17, the pull bar 20 is pushed towards to the divider 32, with the force applied to the pressing handle 30 by the second spring 35, the positioning aperture 321 of the divider 32 engages with the pull bar 20 to provide clamping function. When the spring clamp 10 is holding an object, it is not necessary to keep pressing the first grip 15 and the second grip 17 together. On the other hand, in order to release the object, by pressing the pressing portion 34 of the pressing handle 30 under the second grip 17 to rotate the pressing handle 30 around the pivoting portion 31 to remove the relative included angle between the divider 32 and the pull bar 20 such that the pull bar 20 is able to move out of the positioning aperture 321, and the first spring 14 pushes the first arm 11 and the second arm 12 towards back out again.

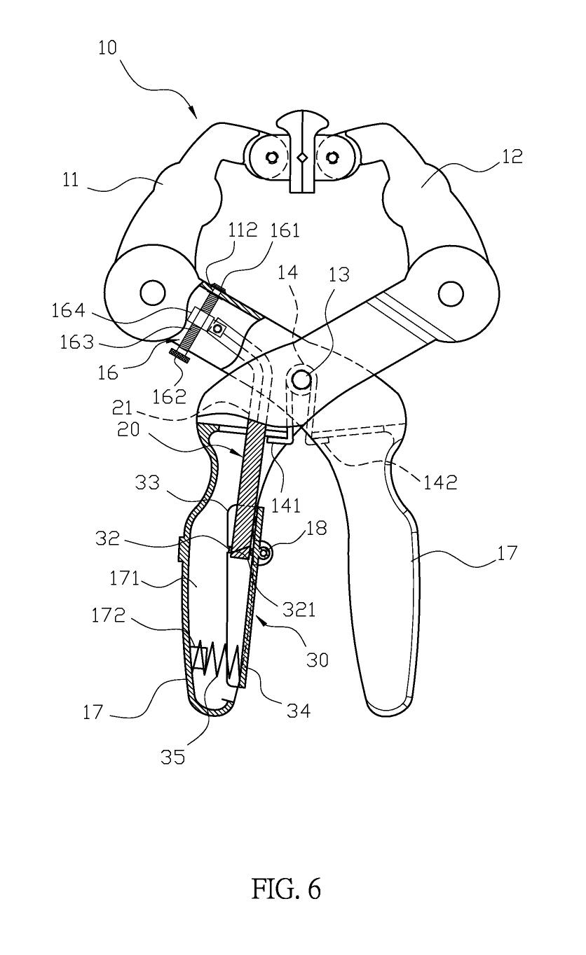

For another embodiment of the present invention, please refer to FIG. 6 again. The first arm 11 further comprises a limiting aperture 112, and the connecting bar 16 utilizes at least one C type hook 161 to be pivoted onto the limiting aperture 112. Another end of the connecting bar 16 further comprises an adjusting head 162 adjacent to the first arm 11, and the connecting bar 16 is further provided with a threaded section 163 engaging with a linkage member 164 connected to the pull bar 20. Accordingly, when the spring clamp 10 is clamping an object, the adjusting head 162 of the connecting bar 16 is rotated, the linkage member 164 moves along the threaded section 163 to pull the pull bar 20 for adjustment. When the linkage member 164 moves away from the adjusting head 162, the clamping strength provided by the spring clamp 10 is increased; on the other hand, when the linkage member 164 moves close to the adjusting head 162, the clamping strength provided by the spring clamp 10 is decreased.

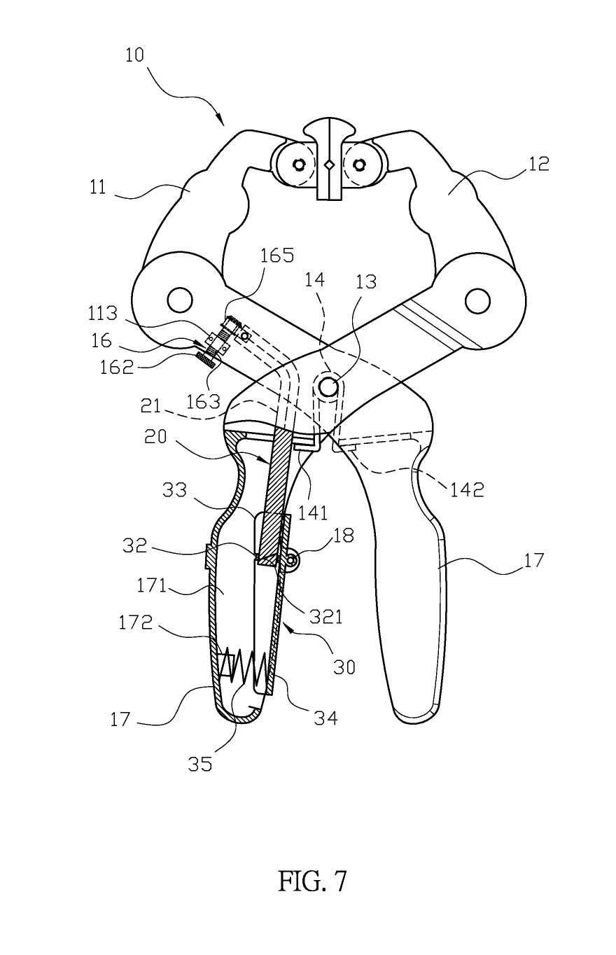

For another embodiment of the present invention, please refer to FIG. 7. The first arm 11 is provided with a threaded insert 113, and the threaded section 163 of the connecting bar 16 engages with the threaded insert 113. An end of the connecting bar 16 further comprises an adjusting head 162 adjacent to the first arm 11 and another end of the connecting bar 16 is connected to a loop 165 connecting to the pull bar 20. Accordingly, when the spring clamp 10 is clamping an object, the adjusting head 162 of the connecting bar 16 is rotated, the threaded section 163 of the connecting bar 16 moves along the threaded inserts 113 to make the loop 165 to pull the pull bar 20 for adjustment. When the loop 165 moves away from the threaded inserts 113, the clamping strength provided by the spring clamp 10 is increased; on the other hand, when the loop 165 moves close to the threaded inserts 113, the clamping strength provided by the spring clamp 10 is decreased.

According to the above mentioned embodiments, following benefits can be obtained: (1) The second spring 35 of the spring clamp 10 is sandwiched between the slot 171 of the second grip 17 and the pressing portion 34 of the pressing handle 30 and disposed away from the pivoting portion 31 of the pressing handle 30, the divider 32 is secured close to the pivoting portion 31 such that a distance between the second spring 35 and the pivoting portion 31 longer than a distance between the divider 32 and the pivoting portion 31, to increase the force provided by the second spring 35. Therefore, the positioning aperture 321 engages with the pull bar 20 with an angle which can increases the clamping strength. (2) The second spring 35 can be assembled and replaced for different purpose easily. (3) The pull bar 20 is provided with the curved section 21, the curved section 21 match the relative angle between the first arm 11 and the second grip 17, to increase the distance between the connecting bar 16 and the shaft rod 13. Therefore, relative moving distance between the pull bar 20 and the divider 32 is increased, which can increase the opening range between the first arm 11 and the second arm 12 and improve the engagement between the pull bar 20 and the divider 32. (4) The pressing handle 30 is pivoted between the first grip 15 and the second grip 17 and in the slot 171 of the second grip 17, which can prevent improper operation.

Although the present invention has been explained in relation to its preferred embodiment, it is to be understood that many other possible modifications and variations can be made without departing from the spirit and scope of the invention as hereinafter claimed.

What is claimed is:

1. An improved spring clamp structure comprising:
a spring clamp having a first arm, a second arm, a shaft rod and a first spring; the first spring jacketed onto the shaft rod, the shaft rod pivoted between the first arm and the second arm, the first arm provided with a first grip; the first arm connected to a connecting bar; the second arm provided with a second grip, the second grip provided with a slot facing the first grip and a linkage rod across the slot;
a pull bar, an end of the pull bar connected to the connecting bar of the first arm, and another end of the pull bar disposed in the slot of the second grip; and
a pressing handle disposed in the slot of the second grip and covering the pull bar, the pressing handle provided with a pivoting portion accepting the linkage rod, the pressing handle further provided with a divider close to the pivoting portion and a positioning aperture disposed on the divider; the positioning aperture jacketed onto the pull bar; the pressing handle further provided with a pressing portion opposite from an end of the pull bar and a second spring between the pressing portion and the second grip.

2. The spring clamp as claimed in claim 1, wherein the pull bar further comprises a curved section corresponding to a relative angle between the first arm and the second grip to increase a distance between the connecting bar and the shaft rod.

3. The spring clamp as claimed in claim 1, wherein the pressing handle is made of plastic and two sides of the pressing handle respectively extend as a sidewall with an engaging groove corresponding to each other; and the divider is made of metal and the divider is inserted into the engaging groove of the sidewall.

4. The spring clamp as claimed in claim 1, wherein the second grip further comprises a protrusion in the slot, and the protrusion is inserted into the second spring for positioning.

5. The spring clamp as claimed in claim 1, wherein the first spring further comprises a front end portion and a rear end portion, and the front end portion of the first spring is engaged with the second arm and the rear end portion is engaged with the first arm.

6. The spring clamp as claimed in claim 1, wherein the second grip is further provided with a metal member, a through aperture is disposed in the metal member, and the through aperture is configured for accepting the linkage rod.

7. The spring clamp as claimed in claim 1, wherein the first arm further comprises a securing aperture, and the connecting bar is inserted into the securing aperture and through the pull bar to provide a pivoting function.

8. The spring clamp as claimed in claim 1, wherein the first arm further comprises a limiting aperture, the connecting bar utilizes at least one C type hook to be pivoted onto the limiting aperture, another end of the connecting bar further comprises an adjusting head adjacent to the first arm, and the connecting bar is further provided with a threaded section engaging with a linkage member connected to the pull bar.

9. The spring clamp as claimed in claim 1, wherein the first arm is provided with a threaded insert, the connecting bar is further provided with a threaded section engaging with the threaded insert, and an end of the connecting bar further comprises an adjusting head adjacent to the first arm and another end of the connecting bar is connected to a loop connecting to the pull bar.
